(19) United States
(12) Patent Application Publication
(10) Pub. No.: US 2025/0111700 A1
(43) Pub. Date: Apr. 3, 2025

(54) PARCEL SORTING BEHAVIOR IDENTIFICATION METHOD AND DEVICE

(71) Applicant: JINGDONG TECHNOLOGY INFORMATION TECHNOLOGY CO., LTD., Beijing (CN)

(72) Inventors: Shaojie ZHENG, Beijing (CN); Wei YU, Beijing (CN); Zhiyong CHEN, Beijing (CN); Linfang WANG, Beijing (CN); Tao MEI, Beijing (CN); Chen YANG, Beijing (CN)

(21) Appl. No.: 18/730,254

(22) PCT Filed: Nov. 11, 2022
(86) PCT No.: PCT/CN2022/131496

§ 371 Date: Jul. 18, 2024

(30) Foreign Application Priority Data
Feb. 23, 2022 (CN) 202210168877.6

(51) Int. Cl. G06V 40/20; B07C 7/00; G06V 10/62; G06V 20/40; G06V 20/52

(52) U.S. Cl. CPC G06V 40/28; B07C 7/005; G06V 10/62; G06V 20/41; G06V 20/52

(57) ABSTRACT

A method and an apparatus of recognizing a package sorting behavior are provided. A target detection is performed on an image frame in a target video, so as to acquire at least one human detection box and at least one package detection box; a motion trajectory of the human detection box and a motion trajectory of the package detection box are tracked respectively; in a process of trajectory tracking for a package, a moment at which the package is thrown is recognized based on a current motion trajectory tracked for the package; and motion information of the package from the moment at which the package is thrown to a current moment is acquired, and a sorting behavior of the package is recognized based on the motion information.

### CROSS REFERENCE TO RELATED APPLICATION

This application corresponds to PCT application No. PCT/CN2022/131496, which claims priority to Chinese Patent Application No. 202210168877.6, filed on Feb. 23, 2022, the entire content of which is incorporated herein in its entirety by reference.

### TECHNICAL FIELD

The present disclosure relates to the field of computer vision technology, and in particular to a method and an apparatus of recognizing a package sorting behavior.

### BACKGROUND

With the continuous development of e-commerce, online shopping, and logistics industries, people's demand for express delivery services is also increasing. In the rapid development of the express delivery industry, sorters often sort packages in a violent manner such as throwing packages to improve a sorting speed, which may cause damage to the items inside the package and harm the interests of consumers and merchants.

### SUMMARY

In view of this, an objective of the present disclosure is to propose a method of recognizing a package sorting behavior, including: performing a target detection on an image frame in a target video, so as to acquire at least one human detection box and at least one package detection box: tracking a motion trajectory of the human detection box and a motion trajectory of the package detection box respectively: recognizing, in a process of trajectory tracking for a package, a moment at which the package is thrown based on a current motion trajectory tracked for the package; and acquiring motion information of the package from the moment at which the package is thrown to a current moment, and recognizing a sorting behavior of the package based on the motion information.

A second objective of the present disclosure is to propose an apparatus of recognizing a package sorting behavior.

A third objective of the present disclosure is to propose an electronic device.

A fourth objective of the present disclosure is to propose a non-transitory computer-readable storage medium.

A fifth objective of the present disclosure is to propose a computer program product.

A sixth objective of the present disclosure is to propose a computer program.

To achieve the above objectives, the embodiments of the first aspect of the present disclosure propose a method of recognizing a package sorting behavior, including: performing a target detection on an image frame in a target video, so as to acquire at least one human detection box and at least one package detection box; tracking a motion trajectory of the human detection box and a motion trajectory of the package detection box respectively: recognizing, in a process of trajectory tracking for a package, a moment at which the package is thrown based on a current motion trajectory tracked for the package; and acquiring motion information of the package from the moment at which the package is thrown to a current moment, and recognizing a sorting behavior of the package based on the motion information.

To achieve the above objectives, the embodiments of the second aspect of the present disclosure propose an apparatus of recognizing a package sorting behavior, including: a first acquisition module configured to perform a target detection on an image frame in a target video, so as to acquire at least one human detection box and at least one package detection box: a trajectory tracking module configured to track a motion trajectory of the human detection box and a motion trajectory of the package detection box respectively: a second acquisition module configured to, recognize, in a process of trajectory tracking for a package, a moment at which the package is thrown based on a current motion trajectory tracked for the package; and a behavior recognition module configured to acquire motion information of the package from the moment at which the package is thrown to a current moment, and recognize a sorting behavior of the package based on the motion information.

To achieve the above objectives, the embodiments of the third aspect of the present disclosure propose an electronic device, including: at least one processor; and a memory communicatively connected to the at least one processor, where the memory stores instructions executable by the at least one processor, and the instructions, when executed by the at least one processor, implements the method of recognizing a package sorting behavior according to the embodiments of the first aspect of the present disclosure.

To achieve the above objectives, the embodiments of the fourth aspect of the present disclosure propose a non-transitory computer-readable storage medium having a computer instructions stored thereon, where the computer instructions are configured to implement the method of recognizing a package sorting behavior according to the embodiments of the first aspect of the present disclosure.

To achieve the above objectives, the embodiments of the fifth aspect of the present disclosure propose a computer program product, including a computer program, where the computer program, when executed by a processor, implements the method of recognizing a package sorting behavior according to the embodiments of the first aspect of the present disclosure.

To achieve the above objectives, the embodiments of the sixth aspect of the present disclosure propose a computer program, including computer program code, where the computer program code, when running on a computer, causes the computer to implement the method of recognizing a package sorting behavior according to the embodiments of the first aspect of the present disclosure.

### BRIEF DESCRIPTION OF THE DRAWINGS

FIG. 1 is a schematic diagram of a method of recognizing a package sorting behavior in an embodiment of the present disclosure.

FIG. 2 is a schematic diagram of a trajectory of a package sorted by one person in an embodiment of the present disclosure.

FIG. 3 is a schematic diagram of recognizing a moment at which a package is thrown in an embodiment of the present disclosure.

FIG. 4 is a schematic diagram of recognizing a sorting behavior of a package in an embodiment of the present disclosure.

FIG. 5 is a schematic diagram of respectively tracking a motion trajectory of a human detection box and a motion trajectory of a package detection box in an embodiment of the present disclosure.

FIG. 6 is a schematic diagram of a method of recognizing a package sorting behavior in an embodiment of the present disclosure.

FIG. 7 is a schematic diagram of an apparatus of recognizing a package sorting behavior in an embodiment of the present disclosure.

FIG. 8 is a schematic diagram of an electronic device in an embodiment of the present disclosure.

### DETAILED DESCRIPTION OF EMBODIMENTS

The embodiments of the present disclosure are described in detail below. Examples of the embodiments are shown in the accompanying drawings, where same or similar labels throughout represent same or similar components or components with same or similar functions. The embodiments described below with reference to the accompanying drawings are exemplary and intended to explain the present disclosure, but cannot be understood as limitations to the present disclosure.

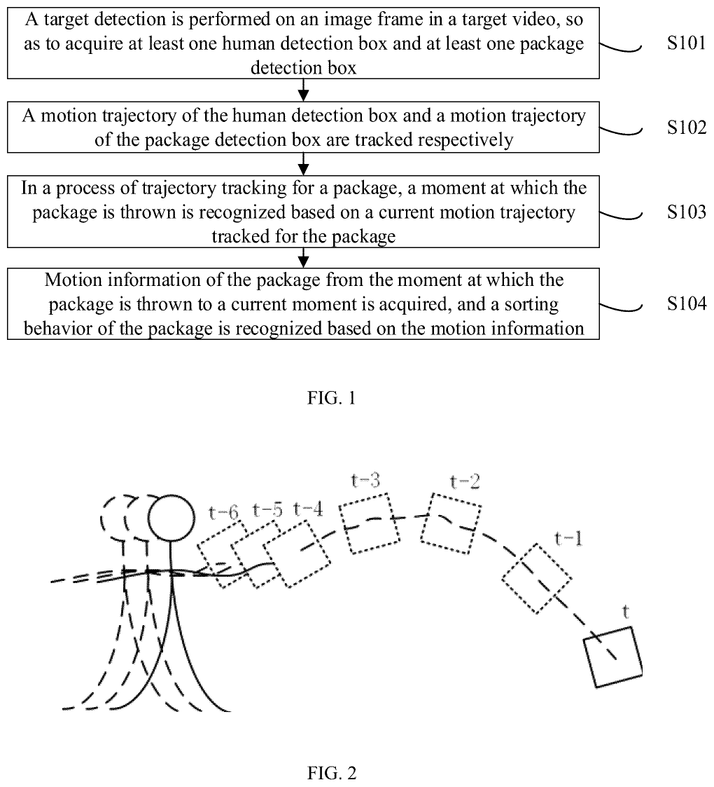

FIG. 1 is an exemplary embodiment of a method of recognizing a package sorting behavior proposed in the present disclosure. As shown in FIG. 1, the method of recognizing a package sorting behavior includes steps S101 to S104.

In S101, a target detection is performed on an image frame in a target video, so as to acquire at least one human detection box and at least one package detection box.

A video to be analyzed for the package sorting behavior is taken as the target video, where the target video may be a video of the sorter sorting the package obtained in real-time, or a video of the sorter sorting the package stored or received locally. The target video is decoded and frames are extracted from the target video, so as to acquire a plurality of image frames corresponding to the target video at different moments. Target detection is performed on all image frames corresponding to the target video, so as to acquire the human detection box P_{box}(t1) corresponding to the sorter in each image frame, and acquire the package detection box Bbox (t2) corresponding to the sorted package, where t1 and t2 are frame indexes of the image frames corresponding to the human detection box and the package detection box, respectively. Each detection box contains coordinate information of the detection box in the image frame.

In some embodiments, the target detection algorithm may include Feature Pyramid Networks (FPN) and Convolutional Neural Networks (CNN). There may be one or more human detection boxes in each image frame, and there may also be one or more package detection boxes in each image frame. When there are a plurality of sorters in the image frame, there are a plurality of human detection boxes in the image frame. When there are a plurality of sorted packages in the image frame, there are a plurality of package detection boxes in the image frame.

In S102, a motion trajectory of the human detection box and a motion trajectory of the package detection box are tracked respectively.

The at least one human detection box and the at least one package detection box of each image frame obtained above are assigned with identification information respectively. According to the identification information of the human detection box and the identification information of the package detection box, the motion trajectory of the human detection box and the motion trajectory of the package detection box are tracked respectively, so as to obtain the human motion trajectory P_{track}(i, t1) and the package motion trajectory B_{track}(j, t2), where i represents the identification information of the human, t1 represents the tracking status of the human at the latest t1 image frame, j represents the identification information of the package, and t2 represents the tracking status of the package at the latest t2 image frame. In some embodiments, target tracking may be performed using tracking algorithms such as nearest neighbor matching and Simple Online and Realtime Tracking (SORT).

In S103, in a process of trajectory tracking for a package, a moment at which the package is thrown is recognized based on a current motion trajectory tracked for the package.

In the process of trajectory tracking, the tracking trajectory of each package is traversed to determine the moment at which the package is thrown. FIG. 2 is a schematic diagram of sorting a package by a person. As shown in FIG. 2, one package is taken as an example. Image frames corresponding to the package are traced backwards from the current frame, that is, starting from the image frame at moment t shown in FIG. 2, image frames corresponding to moments t−1, t−2, t−3, t−4, t−5, and t−6 are sequentially traced. The image frames are analyzed to determine whether the package is thrown by the sorter. If it is determined that the package is thrown by the sorter, the image frame where the package is thrown may be recognized, and the moment corresponding to the image frame where the package is thrown is determined as a throwing moment. As shown in FIG. 2, a distance between the package detection box of the package and the human detection box on the image frame at moment t−4 is less than a distance threshold. That is, at moment t−4, the sorter throws the package, and moment t−4 is the moment at which the package is thrown.

In S104, motion information of the package from the moment at which the package is thrown to a current moment is acquired, and a sorting behavior of the package is recognized based on the motion information.

During the period from moment t−6 to moment t−5 and moment t−4 in FIG. 2, the sorter is moving with the package in hand, and the package does not detach from the human. Any movement during such period is not determined as a candidate for the sorting behavior. After moment t−4, the package begins to detach from the human, and at this moment, the package is thrown. In order to exclude misjudgments caused by the sorter's own large movement or the delivery and receiving behavior between sorters, the various motion information of the package, such as acceleration, movement distance, average speed, etc., are only acquired from the moment at which the package is thrown to the current moment. Due to the significant differences in acceleration, movement distance, and average speed between handling packages lightly and violently throwing packages, movement physical quantities such as acceleration, movement distance, and average speed may be used to reflect the sorting force of the sorter. Based on the acquired various motion information, the sorting behavior parameter of the sorter may be acquired. By comparing the sorting behavior parameter with the parameters in the existing sorting behavior standards, the sorting behavior of the sorter may be recognized. In some embodiments, when acquiring the sorting behavior parameter of the sorter, parameter comparison may be performed based on various motion information to recognize the sorting behavior of the sorter. Parameters in the sorting behavior standards may be set differently according to different types of package scenarios.

The embodiments of the present disclosure propose a method of recognizing a package sorting behavior, including: performing a target detection on an image frame in a target video, so as to acquire at least one human detection box and at least one package detection box: tracking a motion trajectory of the human detection box and a motion trajectory of the package detection box respectively: in a process of trajectory tracking for a package, recognizing a moment at which the package is thrown based on a current motion trajectory tracked for the package; and acquiring motion information of the package from the moment at which the package is thrown to a current moment, and recognizing a sorting behavior of the package based on the motion information. In the present disclosure, when recognizing the package sorting behavior, by determining an interaction relationship between the human and the package, misjudgments caused by situations in which only the person is moving, only the package is moving, or the person is moving with the package, or interference from irrelevant background information may be effectively eliminated, a main body of the sorter may be recognized, and a sorting force level may be determined, so that the determination of the package sorting behavior is more accurate.

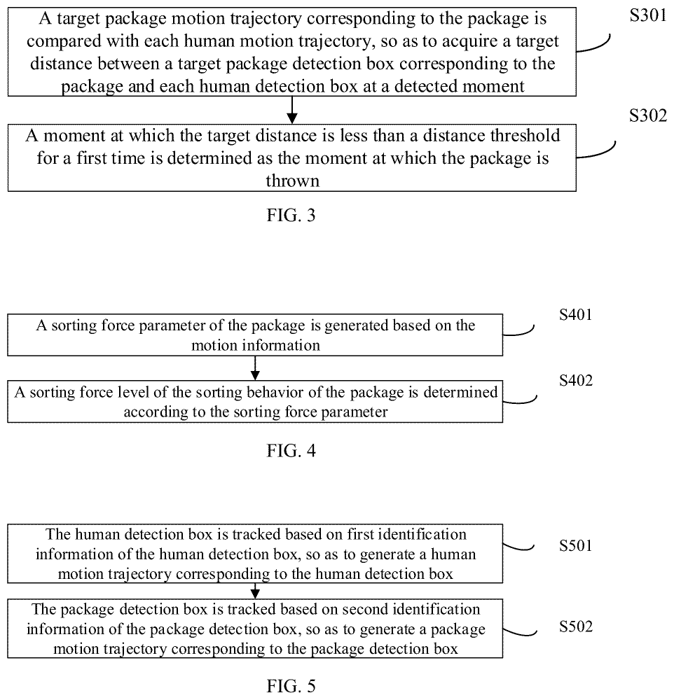

FIG. 3 is an exemplary embodiment of a method of recognizing a package sorting behavior proposed in the present disclosure. As shown in FIG. 3, recognizing, for the package, the moment at which the package is thrown based on the current motion trajectory tracked for the package includes steps S301 to S302.

In S301, a target package motion trajectory corresponding to the package is compared with each human motion trajectory, so as to acquire a target distance between a target package detection box corresponding to the package and each human detection box at a detected moment.

According to the target package motion trajectory, the current image frame is traced backwards in a reverse chronological order, from the most recent to the earliest, so as to acquire position information of the target package detection box on each image frame as a first position information, as well as acquire position information of the human detection box on the same image frame, as a second position information.

In an embodiment of the present disclosure, if there is only one sorter, that is, if there is only one human detection box on the image frame, a distance between the first position information of the target package detection box on each image frame and the second position information of the one human detection box at the corresponding moment is calculated as the target distance.

In another embodiment of the present disclosure, if there are a plurality of sorters, there are a plurality of human detection boxes on the same image frame. Due to the large size of the human detection box, when calculating the distance between the first position information of the target package detection box and the second position information of all human detection boxes on the image frame at the corresponding moment, if a sorter throws a package far away and the package flies over a certain sorter, the distance between the first position information of the target package detection box and the second position information of the certain sorter who have been flown over by the package on the image frame may be calculated first, resulting in a deviation. Therefore, if there are a plurality of sorters, human key point detection may be performed on the human detection box on the image frame to acquire human hand position information. Accordingly, the distance between the first position information of the target package detection box and each human hand position information on the image frame at the corresponding moment is acquired as the target distance. In some embodiments, the human key point detection algorithm may be the human skeleton key point detection algorithm, etc.

In S302, a moment at which the target distance is less than a distance threshold for a first time is determined as the moment at which the package is thrown.

The distance threshold is preset. A moment corresponding to an image frame in which the target distance is less than the distance threshold for the first time is determined as the moment at which the package is thrown, and at the same time, the sorter corresponding to the package may also be determined.

In the embodiments of the present disclosure, the moment at which the package is thrown is recognized based on the current motion trajectory tracked for the package, which may determine the interaction relationship between the package and the human, and thus determine who threw the package, when the package is thrown, and the throwing trajectory, thereby recognizing the package sorting behavior more accurately.

FIG. 4 is an exemplary embodiment of a method of recognizing a package sorting behavior proposed in the present disclosure. As shown in FIG. 4, recognizing a sorting behavior of the package based on the motion information includes steps S401 to S402.

In S401, a sorting force parameter of the package is generated based on the motion information.

Each package may be taken as the target package. Various motion information for each target package from the moment at which the package is thrown to the current moment may be acquired. In some embodiments, the motion information may include a distance value, a maximum speed, and an average speed of each target package from the moment at which the package is thrown to the current moment, as well as a motion speed and an acceleration of each target package at each moment from the moment at which the package is thrown to the current moment.

In an embodiment of the present disclosure, a numerical value of each motion information may be used as a motion parameter for the motion information. For example, if a distance value of a package from the moment at which the package is thrown to the current moment is 3 meters, then the 3 meters may be used as the motion parameter of the distance value from the moment at which the package is thrown to the current moment.

In S402, a sorting force level of the sorting behavior of the package is determined according to the sorting force parameter.

Sorting behavior standards may be set differently according to different scenarios. For example, when the package is a fresh product, the items inside the package are relatively fragile. When the distance value from the moment at which the package is thrown to the current moment to the current moment is used as a parameter, a range of the parameter may be set to be relatively small. For example, when the distance value from the moment at which the fresh package is thrown to the current moment is less than 0.2 meters, the sorting behavior is normal: when the distance value is in a range of 0.2 meters to 0.4 meters, the sorting behavior is mild violence; when the distance value is in a range of 0.4 meters to 0.7 meters, the sorting behavior is moderate violence: when the distance value is in a range of 0.7 meters to 1 meter, the sorting behavior is severe violence. The distance value of the package from the moment at which the package is thrown to the current moment is compared with the parameter in the sorting behavior standards, so as to recognize the sorting behavior of the sorter corresponding to the package.

For another example, when the package is a clothing product, it is difficult to deform due to throwing. Therefore, the sorting behavior standards for the fresh clothing product are stricter than those for the fresh product.

Similarly, sorting behavior standards for other motion information such as acceleration and average speed may be set for comparison, so as to recognize the sorting behavior of the sorter corresponding to the target package.

In the embodiments of the present disclosure, the sorting force level of the sorting behavior of the package is determined according to the motion information, which may provide detailed indicators for the sorter when sorting packages. In addition, different standards for the sorting behavior of the sorter may be set in different business scenarios, which may improve the accuracy and universality of sorting behavior recognition.

FIG. 5 is an exemplary embodiment of a method of recognizing a package sorting behavior proposed in the present disclosure. As shown in FIG. 5, tracking a motion trajectory of the human detection box and a motion trajectory of the package detection box respectively includes steps S501 to S502.

In S501, the human detection box is tracked based on first identification information of the human detection box, so as to generate a human motion trajectory corresponding to the human detection box.

Each human detection box within the image frame is assigned with identification information, as the first identification information. Based on the first identification information corresponding to each human detection box, the human detection box in each image frame is tracked to generate the human motion trajectory corresponding to the human detection box. In some embodiments, target tracking may be performed using tracking algorithms such as nearest neighbor matching and Simple Online and Realtime Tracking (SORT).

In S502, the package detection box is tracked based on second identification information of the package detection box, so as to generate a package motion trajectory corresponding to the package detection box.

Each package detection box within the image frame is assigned with identification information, as the second identification information. Based on the second identification information corresponding to each package detection box, the package detection box in each image frame is tracked to generate the package motion trajectory corresponding to the package detection box. In some embodiments, target tracking may be performed using tracking algorithms such as nearest neighbor matching and Simple Online and Realtime Tracking (SORT).

In this embodiment, the human motion trajectory and the package motion trajectory may be acquired by tracking the motion trajectory of the human detection box and the motion trajectory of the package detection box, thereby laying the foundation for achieving interaction between the human and the package and acquiring the moment at which the package is thrown.

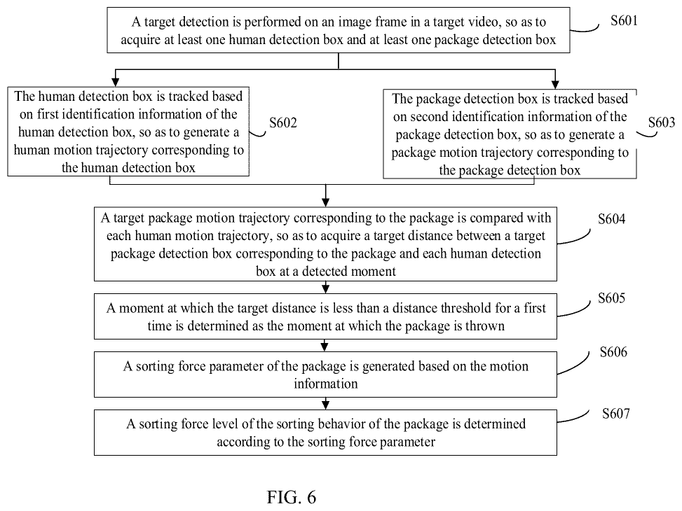

FIG. 6 is an exemplary embodiment of a method of recognizing a package sorting behavior proposed in the present disclosure. As shown in FIG. 6, the method of recognizing a package sorting behavior includes steps S601 to S607.

In S601, a target detection is performed on an image frame in a target video, so as to acquire at least one human detection box and at least one package detection box.

In S602, the human detection box is tracked based on first identification information of the human detection box, so as to generate a human motion trajectory corresponding to the human detection box.

In S603, the package detection box is tracked based on second identification information of the package detection box, so as to generate a package motion trajectory corresponding to the package detection box.

Regarding the implementation methods of steps S602 to S603, the implementation methods in the above embodiments in the present disclosure may be adopted, which will not be further elaborated here.

In S604, a target package motion trajectory corresponding to the package is compared with each human motion trajectory, so as to acquire a target distance between a target package detection box corresponding to the package and each human detection box at a detected moment.

In S605, a moment at which the target distance is less than a distance threshold for a first time is determined as the moment at which the package is thrown.

Regarding the implementation methods of steps S604 to S605, the implementation methods in the above embodiments in the present disclosure may be adopted, which will not be further elaborated here.

In S606, a sorting force parameter of the package is generated based on the motion information.

In S607, a sorting force level of the sorting behavior of the package is determined according to the sorting force parameter.

The embodiments of the present disclosure propose a method of recognizing a package sorting behavior, including: performing a target detection on an image frame in a target video, so as to acquire at least one human detection box and at least one package detection box: tracking a motion trajectory of the human detection box and a motion trajectory of the package detection box respectively: recognizing, in a process of trajectory tracking for a package, a moment at which the package is thrown based on a current motion trajectory tracked for the package; and acquiring motion information of the package from the moment at which the package is thrown to a current moment, and recognizing a sorting behavior of the package based on the motion information. In the present disclosure, when recognizing the package sorting behavior, by determining an interaction relationship between the human and the package, caused by situations in which only the person is moving, only the package is moving, or the person is moving with the package, or interference from irrelevant background information may be effectively eliminated, a main body of the sorter may be recognized, and a sorting force level may be determined, so that the determination of the package sorting behavior is more accurate.

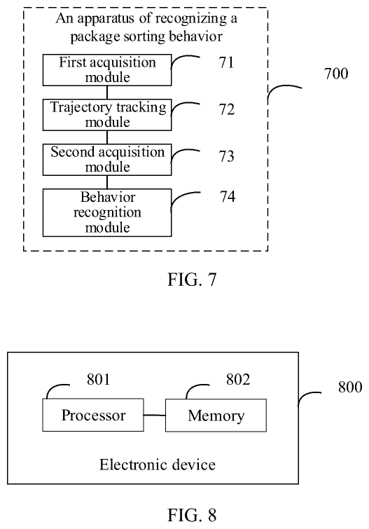

FIG. 7 is a schematic diagram of an apparatus of recognizing a package sorting behavior proposed in the present disclosure. As shown in FIG. 7, an apparatus 700 of recognizing a package sorting behavior includes a first acquisition module 71, a trajectory tracking module 72, a second acquisition module 73, and a behavior recognition module 74.

The first acquisition module 71 is used to perform a target detection on an image frame in a target video, so as to acquire at least one human detection box and at least one package detection box.

The trajectory tracking module 72 is used to track a motion trajectory of the human detection box and a motion trajectory of the package detection box respectively.

The second acquisition module 73 is used to recognize, in a process of trajectory tracking for a package, a moment at which the package is thrown based on a current motion trajectory tracked for the package.

The behavior recognition module 74 is used to acquire motion information of the package from the moment at which the package is thrown to a current moment, and recognize a sorting behavior of the package based on the motion information.

In some embodiments, the second acquisition module 73 is further used to: compare a target package motion trajectory corresponding to the package with each human motion trajectory, so as to acquire a target distance between a target package detection box corresponding to the package and each human detection box at a detected moment; and determine a moment at which the target distance is less than a distance threshold for a first time, as the moment at which the package is thrown.

In some embodiments, the second acquisition module 73 is further used to: acquire, from the target package motion trajectory, first position information of the target package detection box on each image frame in a reverse chronological order; acquire, from the human motion trajectory, second position information of the human detection box on the same image frame; and acquire the target distance according to the first position information and the second position information of a corresponding moment.

In some embodiments, the second acquisition module 73 is further used to determine a moment corresponding to an image frame in which the target distance is less than the distance threshold for the first time, as the moment at which the package is thrown.

In some embodiments, the second acquisition module 73 is further used to: extract an image region marked by the second position information from an image frame corresponding to the second position information: perform a human key point detection on the image region to acquire human hand position information; and acquire a distance between the first position information and the human hand position information, as the target distance.

In some embodiments, the behavior recognition module 74 is further used to: generate a sorting force parameter of the package based on the motion information, and determine a sorting force level of the sorting behavior of the package according to the sorting force parameter.

In some embodiments, the motion information in the behavior recognition module 74 includes a distance value, a maximum speed, and an average speed of the package from the moment at which the package is thrown to the current moment, as well as a motion speed and an acceleration of the package at each moment from the moment at which the package is thrown to the current moment.

In some embodiments, the trajectory tracking module 72 is further used to: track the human detection box based on first identification information of the human detection box, so as to generate a human motion trajectory corresponding to the human detection box; and track the package detection box based on second identification information of the package detection box, so as to generate a package motion trajectory corresponding to the package detection box.

In order to achieve the above-mentioned embodiments, the embodiments of the present disclosure further propose an electronic device 800. As shown in FIG. 8, the electronic device 800 includes: at least one processor 801 and a memory 802 communicatively connected to the at least one processor. The memory 802 stores instructions executable by the at least one processor, and the instructions, when executed by the at least one processor 801, implements the method of recognizing a package sorting behavior according to the above-mentioned embodiments.

In order to achieve the above-mentioned embodiments, the embodiments of the present disclosure further propose a non-transitory computer-readable storage medium having computer instructions stored thereon, where the computer instructions are used to cause a computer to implement the method of recognizing a package sorting behavior according to the above-mentioned embodiments.

In order to achieve the above-mentioned embodiments, the embodiments of the present disclosure further propose a computer program product, including a computer program, where the computer program, when executed by a processor, implements the method of recognizing a package sorting behavior according to the above-mentioned embodiments.

In order to achieve the above-mentioned embodiments, the embodiments of the present disclosure further propose a computer program, including computer program code, where the computer program code, when running on a computer, causes the computer to implement the method of recognizing a package sorting behavior according to the above-mentioned embodiments.

It should be noted that, the above explanation of the embodiments of the method of recognizing a package sorting behavior may be also applied to the apparatus, the electronic device, the non-transitory computer-readable storage medium, the computer program product, and the computer program in the above embodiments, which will not be repeated here.

In addition, the terms “first” and “second” are only used for the description purpose and cannot be understood as indicating or implying relative importance or implying the quantity of technical features indicated. Therefore, the features limited to “first” and “second” may explicitly or implicitly include one or more of such features. In the description of the present disclosure, “a plurality of” means two or more, unless otherwise specified.

In the description of the present disclosure, the reference terms “one embodiment”, “some embodiments”, “examples”, “specific examples”, or “some examples” refer to that specific features, structures, materials, or characteristics described in conjunction with the embodiments or examples are included in at least one embodiment or example of the present disclosure. In the present disclosure, the illustrative expressions of the above terms do not necessarily refer to the same embodiments or examples. Moreover, the specific features, structures, materials, or characteristics described may be combined in an appropriate manner in any one or more embodiments or examples. In addition, those skilled in the art may integrate and combine the different embodiments or examples described in the present disclosure, as well as the features of different embodiments or examples, without conflicting with each other.

Although embodiments of the present disclosure have already been shown and described above, it may be understood that the above embodiments are exemplary and cannot be understood as limitations to the present disclosure. Those ordinary skilled in the art may make changes, modifications, substitutions, and variations to the above embodiments within the scope of the present disclosure.

1. A method of recognizing a package sorting behavior, comprising:
performing a target detection on an image frame in a target video, so as to acquire at least one human detection box and at least one package detection box;
tracking a motion trajectory of the human detection box and a motion trajectory of the package detection box respectively;
recognizing, in a process of trajectory tracking for a package, a moment at which the package is thrown based on a current motion trajectory tracked for the package; and
acquiring motion information of the package from the moment at which the package is thrown to a current moment, and recognizing a sorting behavior of the package based on the motion information.

2. The method according to claim 1, wherein the current motion trajectory comprises a human motion trajectory corresponding to a human detection box and a package motion trajectory corresponding to a package detection box, and recognizing, for the package, the moment at which the package is thrown based on the current motion trajectory tracked for the package comprises:
comparing a target package motion trajectory corresponding to the package with each human motion trajectory, so as to acquire a target distance between a target package detection box corresponding to the package and each human detection box at a detected moment; and
determining a moment at which the target distance is less than a distance threshold for a first time, as the moment at which the package is thrown.

3. The method according to claim 2, wherein the comparing a target package motion trajectory corresponding to the package with each human motion trajectory comprises:
acquiring, from the target package motion trajectory, first position information of the target package detection box on each image frame in a reverse chronological order;
acquiring, from the human motion trajectory, second position information of the human detection box on the same image frame; and
acquiring the target distance according to the first position information and the second position information of a corresponding moment.

4. The method according to claim 2, wherein the determining a moment at which the target distance is less than a distance threshold for a first time, as the moment at which the package is thrown comprises:
determining a moment corresponding to an image frame in which the target distance is less than the distance threshold for the first time, as the moment at which the package is thrown.

5. The method according to claim 3, wherein the acquiring the target distance according to the first position information and the second position information of a corresponding moment comprises:
extracting an image region marked by the second position information from an image frame corresponding to the second position information;
performing a human key point detection on the image region to acquire human hand position information; and
acquiring a distance between the first position information and the human hand position information, as the target distance.

6. The method according to claim 1, wherein the recognizing a sorting behavior of the package based on the motion information comprises:
generating a sorting force parameter of the package based on the motion information, and determining a sorting force level of the sorting behavior of the package according to the sorting force parameter.

7. The method according to claim 1, wherein the motion information comprises a distance value, a maximum speed, and an average speed of the package from the moment at which the package is thrown to the current moment, as well as a motion speed and an acceleration of the package at each moment from the moment at which the package is thrown to the current moment.

8. The method according to claim 1, wherein the tracking a motion trajectory of the human detection box and a motion trajectory of the package detection box respectively comprises:
tracking the human detection box based on first identification information of the human detection box, so as to generate a human motion trajectory corresponding to the human detection box; and
tracking the package detection box based on second identification information of the package detection box, so as to generate a package motion trajectory corresponding to the package detection box.

9-16. (canceled)

17. An electronic device, comprising:
at least one processor; and
a memory communicatively connected to the at least one processor,
wherein the memory stores instructions executable by the at least one processor, and the instructions, when executed by the at least one processor, cause the at least one processor to:
perform a target detection on an image frame in a target video, so as to acquire at least one human detection box and at least one package detection box;
track a motion trajectory of the human detection box and a motion trajectory of the package detection box respectively;
recognize, in a process of trajectory tracking for a package, a moment at which the package is thrown based on a current motion trajectory tracked for the package; and
acquire motion information of the package from the moment at which the package is thrown to a current moment, and recognize a sorting behavior of the package based on the motion information.

18. A non-transitory computer-readable storage medium having a computer instructions stored thereon, wherein the computer instructions are configured to cause a computer to:
perform a target detection on an image frame in a target video, so as to acquire at least one human detection box and at least one package detection box;
track a motion trajectory of the human detection box and a motion trajectory of the package detection box respectively;
recognize, in a process of trajectory tracking for a package, a moment at which the package is thrown based on a current motion trajectory tracked for the package; and
acquire motion information of the package from the moment at which the package is thrown to a current moment, and recognize a sorting behavior of the package based on the motion information.

19-20. (canceled)

21. The electronic device according to claim 17, wherein the current motion trajectory comprises a human motion trajectory corresponding to a human detection box and a package motion trajectory corresponding to a package detection box, and the at least one processor is further configured to:
compare a target package motion trajectory corresponding to the package with each human motion trajectory, so as to acquire a target distance between a target package detection box corresponding to the package and each human detection box at a detected moment; and
determine a moment at which the target distance is less than a distance threshold for a first time, as the moment at which the package is thrown.

22. The electronic device according to claim 21, wherein the at least one processor is further configured to:
acquire, from the target package motion trajectory, first position information of the target package detection box on each image frame in a reverse chronological order;
acquire, from the human motion trajectory, second position information of the human detection box on the same image frame; and
acquire the target distance according to the first position information and the second position information of a corresponding moment.

23. The electronic device according to claim 21, wherein the at least one processor is further configured to:
determine a moment corresponding to an image frame in which the target distance is less than the distance threshold for the first time, as the moment at which the package is thrown.

24. The electronic device according to claim 22, wherein the at least one processor is further configured to:
extract an image region marked by the second position information from an image frame corresponding to the second position information;
perform a human key point detection on the image region to acquire human hand position information; and
acquire a distance between the first position information and the human hand position information, as the target distance.

25. The electronic device according to claim 17, wherein the at least one processor is further configured to:
generate a sorting force parameter of the package based on the motion information, and determine a sorting force level of the sorting behavior of the package according to the sorting force parameter.

26. The electronic device according to claim 17, wherein the motion information comprises a distance value, a maximum speed, and an average speed of the package from the moment at which the package is thrown to the current moment, as well as a motion speed and an acceleration of the package at each moment from the moment at which the package is thrown to the current moment.

27. The electronic device according to claim 17, wherein the at least one processor is further configured to:
track the human detection box based on first identification information of the human detection box, so as to generate a human motion trajectory corresponding to the human detection box; and
track the package detection box based on second identification information of the package detection box, so as to generate a package motion trajectory corresponding to the package detection box.

28. The non-transitory computer-readable storage medium according to claim 18, wherein the current motion trajectory comprises a human motion trajectory corresponding to a human detection box and a package motion trajectory corresponding to a package detection box, and the computer instructions are further configured to cause the computer to:
compare a target package motion trajectory corresponding to the package with each human motion trajectory, so as to acquire a target distance between a target package detection box corresponding to the package and each human detection box at a detected moment; and
determine a moment at which the target distance is less than a distance threshold for a first time, as the moment at which the package is thrown.

29. The non-transitory computer-readable storage medium according to claim 28, wherein the computer instructions are further configured to cause the computer to:
acquire, from the target package motion trajectory, first position information of the target package detection box on each image frame in a reverse chronological order;
acquire, from the human motion trajectory, second position information of the human detection box on the same image frame; and
acquire the target distance according to the first position information and the second position information of a corresponding moment.

30. The non-transitory computer-readable storage medium according to claim 28, wherein the computer instructions are further configured to cause the computer to:
determine a moment corresponding to an image frame in which the target distance is less than the distance threshold for the first time, as the moment at which the package is thrown.
